(19) United States
(12) Patent Application Publication
(10) Pub. No.: US 2025/0128529 A1
(43) Pub. Date: Apr. 24, 2025

(54) PRINTING DEVICE AND PRINTING METHOD

(71) Applicant: SEIKO EPSON CORPORATION, Tokyo (JP)

(72) Inventors: Sho SHIMIZU, MATSUMOTO-SHI (JP); Osamu KATSUDA, MATSUMOTO-SHI (JP)

(21) Appl. No.: 18/919,531

(22) Filed: Oct. 18, 2024

(30) Foreign Application Priority Data
Oct. 18, 2023 (JP) 2023-179571

(51) Int. Cl. B41J 15/04; B41J 3/407; B41J 11/00; D06P 1/00

(52) U.S. Cl. CPC B41J 15/048; B41J 3/4078; B41J 11/008; B41J 11/0095; D06P 1/0032

(57) ABSTRACT

A printing device 1 includes a transport belt 5 that transports the fabric M in a transport direction A in a state where the first surface M1 of the fabric M faces the adhesive layer 5a, printing section 101 that prints an image on a second surface M2 of the fabric M transported by the transport belt 5, the second surface M2 being on opposite side than the first surface M1, and an infrared imaging section 30 that captures an image of an imaging target I provided on the first surface M1 by using infrared rays with respect to the fabric M transported by the transport belt 5.

The present application is based on, and claims priority from JP Application Serial Number 2023-179571, filed Oct. 18, 2023, the disclosure of which is hereby incorporated by reference herein in its entirety.

### BACKGROUND

### 1. Technical Field

The present disclosure relates to a printing device and a printing method.

### 2. Related Art

In the related art, various printing devices have been used. Among these, there is a printing device that prints on fabric. For example, JP-T-2022-502291 discloses a double-sided printing system configured to print on both sides of a fabric.

In a printing device that prints on both sides of a fabric, such as the double-sided printing system of JP-T-2022-502291, it is often desirable to align the image printed on the front side with the image printed on the back side. For this reason, there is a configuration in which a detection section is provided that detects the position of the image that was printed beforehand on one surface of the fabric. In the double-sided printing system of JP-T-2022-502291, scanning equipment is provided and it is possible to read a first printed image of the first surface. However, the scanning equipment of the double-sided printing system of JP-T-2022-502291 is a configuration for detecting the position of an image using visible light, the detection capability of the image and the like on the back surface is low, and it is difficult to print an image at a desired position with respect to the image and the like on the back surface in some cases.

### SUMMARY

In order to solve the above problem, a printing device according to present disclosure includes a transport belt that includes an adhesive layer for supporting a fabric as a medium and that transports the fabric in a transport direction in a state where a first surface of the fabric faces the adhesive layer, a printing section that prints an image on a second surface of the fabric transported by the transport belt, the second surface being on an opposite side than the first surface, and

an infrared imaging section that captures an image of an imaging target provided on the first surface by using infrared rays with respect to the fabric transported by the transport belt.

In addition, in order to solve the above problem, a printing method according to an aspect of the disclosure is for a printing device, which including a transport belt that includes an adhesive layer for supporting a fabric as a medium and that transports the fabric in a transport direction in a state where a first surface of the fabric faces the adhesive layer and transports the fabric in a transport direction in a state where a first surface of the fabric faces the adhesive layer, and a printing section that prints an image on a second surface of the fabric transported by the transport belt, that the second surface being on an opposite side than the first surface, the method comprising
an infrared imaging step of capturing an image of an imaging target provided on the first surface by using infrared rays with respect to the fabric transported by the transport belt, a correction step of correcting that corrects at least one of the image and a printing position of the image based on the imaging data captured in the infrared imaging step,
and a printing step of printing the image on the fabric transported by the transport belt by the printing section based on a correction result in the correction step.

### BRIEF DESCRIPTION OF THE DRAWINGS

FIG. 1 is a schematic side view of a printing device according to a first embodiment of the present disclosure.

FIG. 2 is a schematic side view of an infrared imaging section of the printing device of FIG. 1.

FIG. 3 is a flowchart of an example of a printing method using the printing device of FIG. 1.

FIG. 4 is a schematic side view of a printing device according to a second embodiment of the present disclosure.

FIG. 5 is a schematic side view of an infrared imaging section of the printing device of FIG. 4.

FIG. 6 is a schematic side view of a printing device according to a third embodiment of the present disclosure.

FIG. 7 is a schematic side view of an infrared imaging section of the printing device of FIG. 6.

FIG. 8 is a schematic side view of a printing device according to a fourth embodiment of the present disclosure.

FIG. 9 is a schematic side view of an infrared imaging section of the printing device of FIG. 8.

### DESCRIPTION OF EMBODIMENTS

First, the present disclosure will be schematically described.

In order to solve the above problem, a printing device according to a first aspect of the present disclosure includes a transport belt that includes an adhesive layer for supporting a fabric as a medium and that transports the fabric in a transport direction in a state where a first surface of the fabric faces the adhesive layer, a printing section that prints an image on a second surface of the fabric transported by the transport belt, the second surface being on an opposite side than the first surface, and an infrared imaging section that captures an image of an imaging target provided on the first surface by using infrared rays with respect to the fabric transported by the transport belt.

According to this aspect, the infrared imaging section is provided that captures an image of an imaging target on the first surface by using infrared rays with respect to the fabric transported by the transport belt. Since infrared light is more likely to pass through fabric than visible light, it is possible to suitably capture an image of the imaging target. Therefore, when double-sided printing is performed on fabric, an image can be printed on the front side at a desired position relative to the image on the back side.

A printing device according to a second aspect of the disclosure is an aspect according to the first aspect, further including a correction section that corrects at least one of the image and the printing position of the image based on the imaging data captured by the infrared imaging section. According to this aspect, the printing device includes a correction section that corrects at least one of the image and the printing position of the image based on the imaging data captured by the infrared imaging section.

With such a configuration, when double-sided printing is performed on a fabric, based on the correction result by the correction section, an image can be printed automatically and easily at a desired position on the front side relative to the image on the back side.

A printing device according to a third aspect of the disclosure is an aspect according to the first or second aspect, further including a pressing section that presses the fabric to the adhesive layer.

Therefore, the fabric can be firmly supported by the adhesive layer. On the other hand, in the configuration in which the pressing section that presses the fabric to the adhesive layer is provided, it becomes difficult to align the positions of the images on both surfaces when performing double-sided printing on the fabric. However, by providing the infrared imaging section that captures an image of the imaging target provided on the first surface, it is possible to suitably align the positions of the images on both surfaces.

A printing device according to a fourth aspect of the disclosure is an aspect according to the first or second aspect, wherein the transport belt is formed of a material that reflects infrared rays, and the infrared imaging section includes a light emitting section that emits infrared rays and a light receiving section that receives infrared rays on a side facing the second surface.

According to this aspect, the transport belt is formed of a material that reflects infrared rays, and the infrared imaging section includes a light emitting section that emits infrared rays and a light receiving section that receives infrared rays on the side facing the second surface. With such a configuration, the light emitting section and the light receiving section can be disposed on the same side with respect to the transport belt, and it is possible to simplify the device configuration.

A printing device according to a fifth aspect of the disclosure is an aspect according to the first or second aspect, wherein the transport belt is formed of a material through which infrared rays pass, and the infrared imaging section includes a light emitting section that emits infrared rays and a light receiving section that receives infrared rays on a side facing the first surface.

According to this aspect, the transport belt is formed of a material through which infrared rays pass, and the infrared imaging section includes the light emitting section that emits infrared rays and the light receiving section that receives infrared rays on the side facing the first surface. With such a configuration, the light emitting section and the light receiving section can be disposed on the same side with respect to the transport belt, and it is possible to simplify the device configuration.

A printing device according to a sixth aspect of the disclosure is an aspect according to the first or second aspect, wherein the transport belt is formed of a material through which infrared rays pass, and the infrared imaging section includes a light emitting section that emits infrared light on a side facing the first surface, and a light receiving section that receives infrared light on a side facing the second surface.

According to the aspect, the transport belt is formed of a material through which infrared rays pass, and the infrared imaging section includes the light emitting section that emits infrared rays on the side facing the first surface and the light receiving unit that receives infrared rays on the side facing the second surface. With such a configuration, the light emitting section and the light receiving section can be disposed on different sides with respect to the transport belt, making it possible to effectively utilize the space within the device.

A printing device according to a seventh aspect of the disclosure is an aspect according to the first or second aspect, wherein the transport belt is formed of a material through which infrared rays pass, and the infrared imaging section includes a light emitting section that emits infrared rays on a side facing the second surface and a light receiving section that receives infrared rays on a side facing the first surface.

According to this aspect, the transport belt is formed of a material through which infrared rays pass, and the infrared imaging section includes the light emitting section that emits infrared rays on the side facing the second surface and the light receiving unit that receives infrared rays on the side facing the first surface. With such a configuration, the light emitting section and the light receiving section can be disposed on different sides with respect to the transport belt, making it possible to effectively utilize the space within the device.

A printing device according to an eighth aspect of the disclosure is an aspect according to the first or second aspect, wherein the infrared imaging section is detachable and attachable.

According to this aspect, the infrared imaging section is detachable and attachable. Therefore, the infrared imaging section can be easily replaced or cleaned.

A printing device according to a ninth aspect of the disclosure is an aspect according to the first or second aspect, wherein the imaging target is a print image printed in advance by the printing section.

According to this aspect, the imaging target is a printed image printed in advance by the printing section. Therefore, it is possible to form a double-sided printed matter in which the printed image printed in advance by the printing section and the image positioned based on the printed image thereafter are suitably aligned.

A printing method according to an aspect of the disclosure is for a printing device, which includes a transport belt that includes an adhesive layer for supporting a fabric as medium and that transports the fabric in a transport direction in a state where a first surface of the fabric faces the adhesive layer, and a printing section that prints an image on a second surface of the fabric transported by the transport belt, that the second surface being opposites to the first surface, and is a printing method including
an infrared imaging step that captures an image of an imaging target provided on the first surface by using infrared rays with respect to the fabric transported by the transport belt, a correction step that corrects at least one of the image and a printing position of the image based on the imaging data captured in the infrared imaging step and
a printing step that prints the image on the fabric transported by the transport belt by the printing section on the basis of a correction result in the correction step.

According to this aspect, printing by correcting at least one of the image and the print position of the image based on the imaging data captured by the infrared imaging section. By executing such a printing method, when double-sided printing is performed on a fabric, based on the correction result in the correction step, an image can be printed automatically and easily at a desired position.

A printing method according to a tenth aspect of the disclosure is an aspect further including, prior to the infrared imaging step, an imaging target printing step that prints the imaging target by the printing section is executed.

According to this aspect, a print image printed in advance in the imaging target printing step is taken as an imaging target. Therefore, it is possible to form a double-sided printed matter in which the printed image printed in advance in the imaging target printing step and the image positioned and printed based on the printed image in the printing step thereafter are suitably aligned.

### FIRST EMBODIMENT

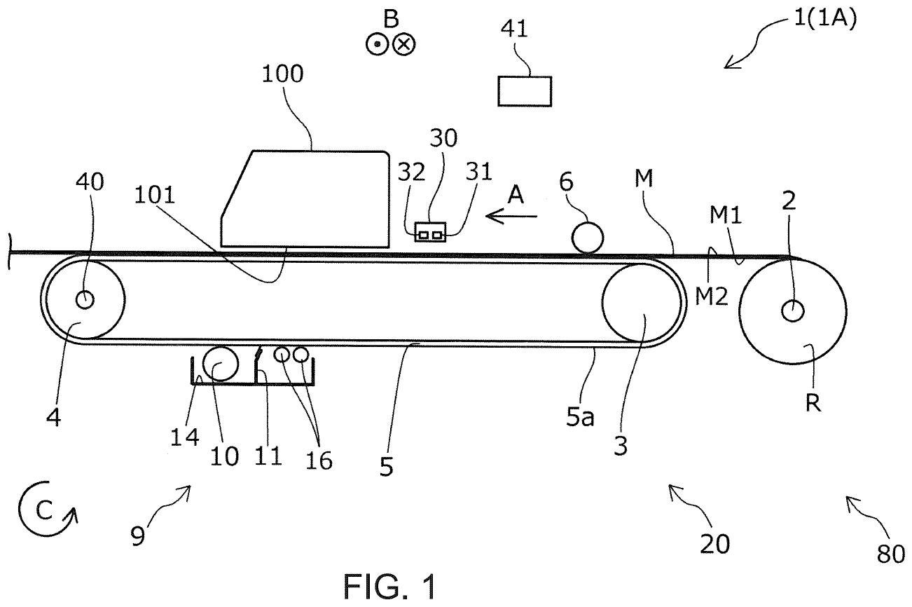

Hereinafter, embodiments of the present disclosure will be described with reference to the accompanying drawings. First, an overview of the printing device 1A of the first embodiment, which is an example of the printing device 1 of the present disclosure, will be described with reference to FIG. 1.

As illustrated in FIG. 1, the printing device 1A of the present embodiment includes a holding section 80 that can rotatably hold a roll body R in which a medium M is wound in a roll shape, and a transport section 20 that has a drive section 40, which is a motor, and that transports the medium M fed from the holding section 80 in a transport direction A by a driving force of the drive section 40. The drive section 40 is driven under the control of the control section 41. The control section 41 includes a central processing unit (CPU) and a storage unit, and performs driving control of each constituent member of the printing device 1A of the present embodiment.

The holding section 80 includes a holding shaft 2 that holds the roll body R to be passed through a paper tube constituting a rotation shaft of the roll body R. The holding section 80 can rotate the holding shaft 2 in the rotation direction C to feed the medium M from the roll body R to the transport section 20. The printing device 1A of the present embodiment includes a pressure roller 6 that presses the medium M against the transport belt 5 in a region facing the transport belt 5 constituting the transport section 20. However, the pressure roller 6 may not be provided.

The transport section 20 includes a driven roller 3, which is located on the upstream side of the transport direction A, a drive roller 4, which is located on the downstream side of the transport direction A, and a transport belt 5, which is an endless belt wound over the driven roller 3 and the drive roller 4. The transport belt 5 is an adhesive belt having an adhesive layer 5a in which an adhesive is applied to a support surface of the medium M which is an outer surface. From another viewpoint, the transport belt 5 is an adhesive belt that includes an adhesive layer 5a that supports the medium M and transports the medium M in the transport direction A in a state where the first surface M1 of the fabric faces the adhesive layer 5a.

As shown in FIG. 1, in a state where the first surface M1 of the medium M is attached to the adhesive layer 5a, the medium M is transported while being supported by the transport belt 5. In the printing device 1A of the present embodiment, the medium support region of transport belt 5 that supports the medium M is the upper region that bridges the driven roller 3 and the drive roller 4. The drive roller 4 is a roller rotated in a rotation direction C by a driving force of the drive section 40, which is a motor, and the driven roller 3 is a roller rotated by being driven by the rotation of the transport belt 5 according to the rotation of the drive roller 4.

The printing device 1A of the present embodiment includes a carriage 100 that can reciprocate in the width direction B of the transport belt 5, and a head 101 attached to the carriage 100. The head 101 is a printing section capable of printing an image by ejecting liquid ink onto the second surface M2 of the medium M transported in the transport direction A.

The printing device 1A of the present embodiment can form an image by ejecting ink from the head 101 onto the transported medium M while reciprocating the carriage 100 in the width direction B, which intersects the transporting direction A. By providing the carriage 100 with such a configuration, the printing device 1A of the present embodiment can form a desired image on the medium M by repeating the process of transporting the medium M in the transport direction A by a predetermined amount and ejecting ink while moving the carriage 100 in the width direction B when the medium M is stopped.

As described above, the printing device 1A of the present embodiment includes a ejection head of a so-called serial head system in which the head 101 mounted on the carriage 100 reciprocates in the width direction B. However, it is not limited to such an ejection head. For example, the head 101 may be a line head type printing section that extends in the width direction B and that is fixed, and that has a plurality of nozzles arranged along the width direction B that eject ink.

In the case of the configuration including the printing section of the line head type, the medium M can be transported by so-called continuous transport in which the medium M is continuously transported, instead of transporting the medium M by so-called intermittent transport in which transporting the medium M by a predetermined transport amount and stopping of the medium M are repeated as in the printing device 1A of the present embodiment.

When the medium M on which an image is formed by ejecting ink from the head 101 is ejected from the printing device 1A of the present embodiment, the medium M is sent to a drying device that volatilizes components of the ink ejected onto the medium M or a winding device that winds up the medium M on which an image is formed, which is provided at a later stage than the printing device 1A of the present embodiment.

As the medium M, a material to be printed such as fabric can be preferably used. Print textile refers to cloth, clothes, other apparel products, and the like that are objects to be printed on. Fabric includes woven, knitted, and non-woven fabrics made of natural fibers such as cotton, silk, and wool, chemical fibers such as nylon, or composite fibers mixed with these fibers. Clothes and other clothing products include sewn T-shirts, handkerchiefs, scarves, towels, carrier bags, bags made of cloth, curtains, sheets, bedspreads, and other furniture, as well as fabric before and after cutting, which exists as parts before being sewn together. However, in addition to the above-mentioned textile print materials, special paper for ink jet printing such as plain paper, high-quality paper, and glossy paper can also be used.

When a textile print material is used as the medium M, the ink ejected onto the textile print material tends to strike-through the back side of the medium M, which is a phenomenon of ink bleeding to the back side, and the transport belt 5 may become dirty with ink. Therefore, the printing device 1A of the present embodiment is provided with a washing section 9 for cleaning the ink that clings to the transport belt 5 due to strike-through. The washing section 9 of the present embodiment includes a storage tank 14 in which the washing liquid is stored, a washing roller 10 that is immersed in the washing liquid and that comes into contact with the transport belt 5, a blade 11 extending in the width direction B and that wipes off the washing liquid clinging to the transport belt 5, and an absorption roller 16 that absorbs the washing liquid that was not wiped off by the blade 11.

As described above, the printing device 1A of the present embodiment includes the transport belt 5 that transports the medium M, such as fabric, in the transport direction A in a state where the first surface M1 of the medium M faces the adhesive layer 5a, and the head 101 that prints an image on the second surface M2, which is opposite to the first surface M1, with respect to the medium M transported by the transport belt 5. As illustrated in FIG. 1, the printing device 1A of the present embodiment further includes an infrared imaging section 30 that captures an image of an imaging target I provided on the first surface M1 by using infrared rays with respect to the medium M transported by the transport belt 5.

In a configuration in which visible light is used as the detection section that detects the imaging target I, in a case where a fabric is used as the medium M, the detection accuracy of the imaging target I decreases. In particular, when a thick felt or the like is used as the medium M, the detection accuracy of the imaging target I is particularly lowered. On the other hand, since infrared light is more likely to pass through fabric or the like than visible light, it is possible to suitably image the imaging target I by adopting a configuration including the infrared imaging section 30 that captures an image of an imaging target I provided on the first surface M1 using infrared light. By capturing an image of an imaging target I, it is possible to form an image at a suitable position on the second surface M2 with respect to the first surface M1 based on the imaging result. Therefore, the printing device 1A of the present embodiment can print an image at a desired front surface position with respect to the image on the back surface, for example, when performing double-sided printing on a fabric.

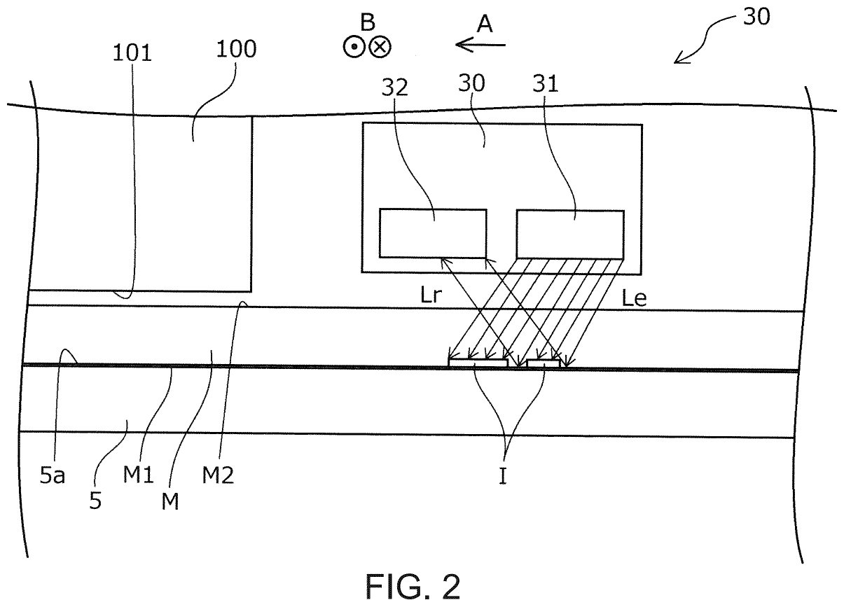

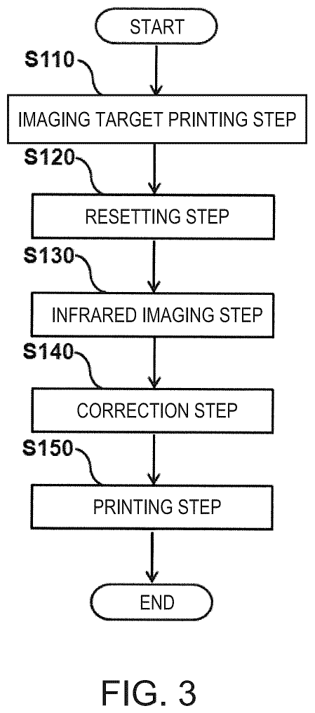

Hereinafter, the infrared imaging section 30 will be described in more detail with reference to FIGS. 2 and 3 in addition to FIG. 1. As illustrated in FIG. 2, in the printing device 1A of the present embodiment, the infrared imaging section 30 includes a light emitting section 31 that emits infrared rays and a light receiving section 32 that receives infrared rays, and includes both the light emitting section 31 and the light receiving section 32 on a side facing the second surface M2. In the printing device 1A of the present embodiment, the transport belt 5 is formed of a material that reflects infrared rays.

FIG. 2 shows a state in which the infrared light Le emitted from the light emitting section 31 is absorbed by the imaging target I, and in a place where the imaging target I is not present, the infrared light Le is reflected by the transport belt 5 to become reflected infrared ray Lr, and is received by the light receiving section 32. As described above, in the printing device 1A of the present embodiment, the transport belt 5 is formed of a material that reflects infrared rays, and the infrared imaging section 30 is provided, on the side facing the second surface, with the light emitting section that emits infrared rays and the light receiving section that receives infrared rays. With such a configuration, the light emitting section 31 and the light receiving section 32 can be disposed on the same side with respect to the transport belt 5, so that the device configuration can be simplified.

For suitably capturing an image of the imaging target I, the light emitting section 31 is arranged such that the light emitting elements are aligned in a line along the width direction B or the transport direction A, or in a configuration where the light emitting elements are arranged in a plane along the width direction B and the transport direction A. Accordingly, the light receiving section 32 is preferably configured such that the light receiving elements are arranged in a line along the width direction B or the transport direction A, or the light receiving elements are arranged in a plane along the width direction B and the transport direction A.

The imaging target I can be various objects such as a pattern or unevenness formed on the first surface M1 of the medium M, a printed image printed on the first surface M1 of the medium M, or a seal attached to the first surface M1 of the medium M. There is no particular limitation on the imaging target I, the imaging target I can be anything that absorbs infrared rays more easily than the medium M. In the present embodiment, the imaging target I is a printed image printed in advance by the head 101 of the printing device 1A of the present embodiment. Therefore, it is possible to form double-sided printed matter in which the printed image printed in advance by the head 101 and the image positioned based on the printed image thereafter are suitably aligned. From another viewpoint, the medium M which can be used in the present embodiment can be medium M in which a printed image is formed on the first surface M1 and an image is not printed on the second surface M2.

When double-sided printed matter is formed, it is possible to form the same image on the first surface M1 and the second surface M2 with their positions aligned. However, in addition to such double-sided printed matter, different images may be formed on the first surface M1 and the second surface M2 by aligning the positions of both, or the same or different images may be formed on the first surface M1 and the second surface M2 by differentiating the positions of both by a predetermined amount.

As described above, the printing device 1A of the present embodiment includes the control section 41, and the control section 41 can serve as a correction section that corrects at least one of the image to be printed by the head 101 and the printing position of the image based on the imaging data captured by the infrared imaging section 30. Since printing device 1A of the present embodiment has such a configuration, when double-sided printing is performed on the medium M based on the correction result by the control section 41 as the control section, a new image can be printed automatically and easily at a desired position of the second surface M2 with respect to an image on the back surface (first surface M1).

Correction of the print position of the image corresponds to, for example, correction of the formation position of the image to be printed on the second surface M2 in correspondence with the print image on the first surface M1 in a case such as when the same image is formed on the first surface M1 and the second surface M2 by aligning the positions of both surfaces. Image correction includes, for example, in a case such as when the same image is to be formed on the first surface M1 and the second surface M2 in alignment with each other and the medium M is attached to the adhesive layer 5a in an expanded or contracted state, by correcting the image data and the like according to the expanded or contracted state, the image data and the like is corrected to make the images on the first surface M1 and on the second surface M2 identical and aligned when the medium M is removed from the adhesive layer 5a and the expanded or contracted state is released.

As shown in FIG. 1, the printing device 1A of the present embodiment includes a pressing section 6 that presses the medium M to the adhesive layer 5a. Therefore, the medium M can be firmly supported by the adhesive layer 5a. On the other hand, in a configuration in which the pressing section 6 that presses the medium M to the adhesive layer 5a is provided, the medium M is easily deformed when pressing the medium M to the adhesive layer 5a and it can be difficult to align the positions of the images on both surface when performing double-sided printing on a soft fabric or the like. However, by providing the infrared imaging section 30 that captures an image of the imaging target I provided on the first surface M1, it is possible to suitably align the positions of the images on both surfaces.

In the printing device 1A of the present embodiment, the infrared imaging section 30 is detachable and attachable. By making the infrared imaging section 30 detachable and attachable, the infrared imaging section 30 can be easily replaced when it is broken, and the infrared imaging section 30 can be easily cleaned when it is dirtied.

Explaining the printing method using printing device 1A of the present embodiment with reference to FIG. 3, it is possible to execute a printing method using printing device 1A of the present embodiment that has an infrared imaging step (step S130) of capturing an image of an imaging target I provided on the first surface M1 by using infrared rays with respect to the medium M transported by transport belt 5, a correction step (step S140) of correcting at least one of the image and the printing position of the image based on the imaging data captured in the infrared imaging step, and a printing step (step S150) of printing the image on the medium M transported by transport belt 5 by the head 101 on the basis of a correction result in the correction step. By executing such a printing method, for example, when double-sided printing is performed on a fabric, based on the correction result in the correction step, an image can be printed automatically and be easily printed at a desired position.

Further, prior to the infrared imaging step, the imaging target printing step (step S110) of printing the imaging target I with the head 101 can also be executed. By executing such a printing method, it is possible to form a double-sided printed matter in which the printed image printed in advance in the imaging target printing step and the image positioned and printed based on the printed image in the printing step thereafter are suitably aligned.

When the above-described printing method is executed using the printing device 1A of the present embodiment, the medium M is once set in the printing device 1A so that the first surface M1 of the medium M faces the head 101 to execute the imaging target printing step, and the re-setting step (step S120) of rewinding the medium M around the roll body R is executed after the imaging target printing step. Thereafter, the medium M is set in the printing device 1A so that the second surface M2 of the medium M faces the head 101, and the infrared imaging step, the correction step, and the printing step are performed.

### SECOND EMBODIMENT

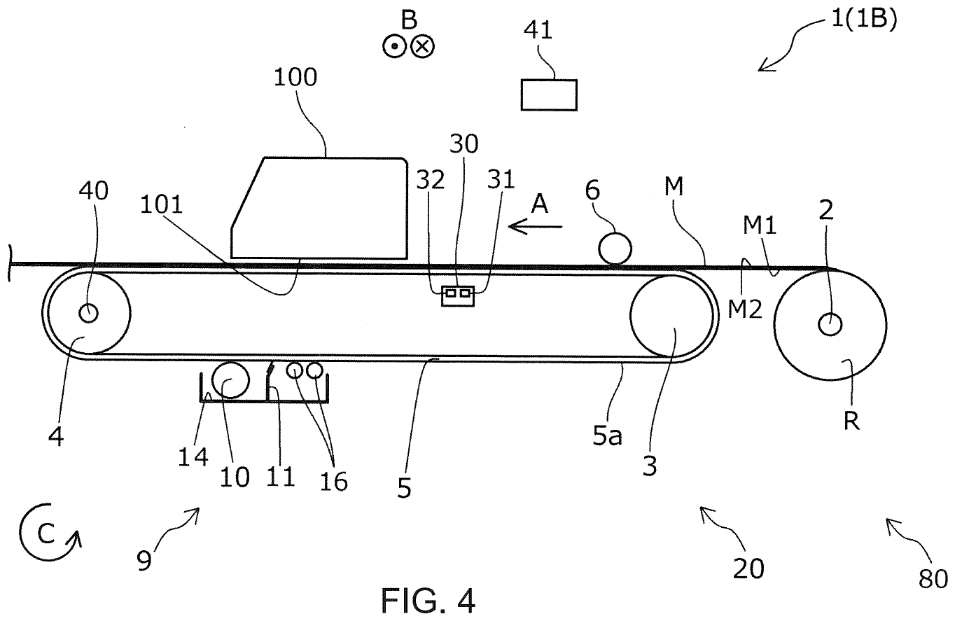

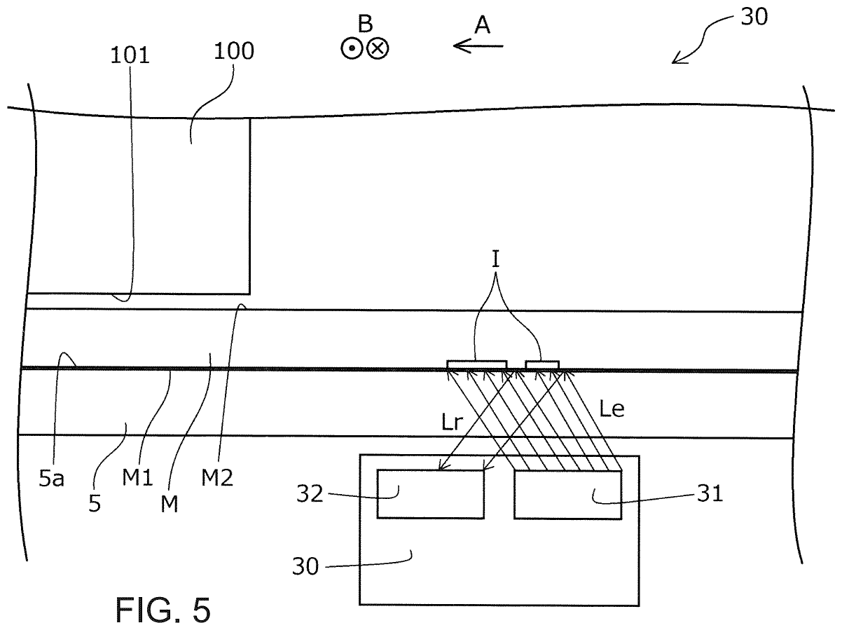

Next, a printing device 1B according to a second embodiment will be described with reference to FIGS. 4 and 5. FIG. 4 is a view corresponding to FIG. 1 of the printing device 1A according to the first embodiment, and FIG. 5 is a view corresponding to FIG. 2 of the printing device 1A according to the first embodiment. In FIGS. 4 and 5, components that are common to those in the above first embodiment are indicated by the same symbols, and detailed explanations are omitted. Here, the printing device 1B of the present embodiment has the same configuration as the printing device 1A of the first embodiment except for the configuration of the infrared imaging section 30. For this reason, the printing device 1B of the present embodiment has the same features as those of the printing device 1A of first embodiment, except for the parts described below.

As described above, in the printing device 1A of the first embodiment, the infrared imaging section 30 includes the light emitting section 31 and the light receiving section 32 provided on the side facing the second surface M2. On the other hand, as illustrated in FIGS. 4 and 5, in the printing device 1B of the present embodiment, the infrared imaging section 30 includes the light emitting section 31 and the light receiving section 32 provided on a side facing the first surface M1. In the printing device 1B of the present embodiment, unlike the printing device 1A of the first embodiment, the transport belt 5 is formed of a material through which infrared rays can pass. With such a configuration, the light emitting section 31 and the light receiving section 32 can be disposed on the same side with respect to the transport belt 5, so that the device configuration can be simplified.

### THIRD EMBODIMENT

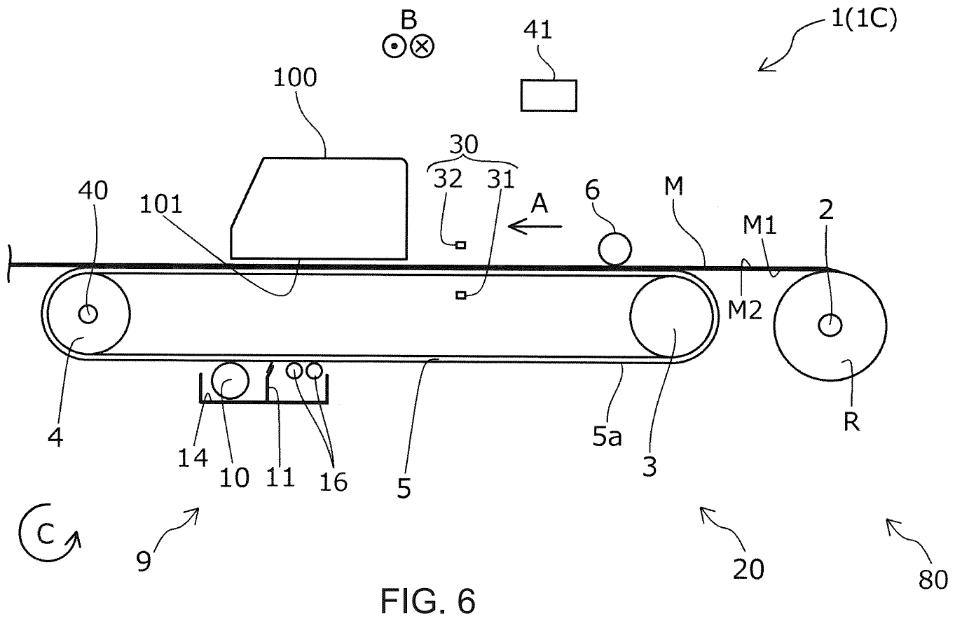

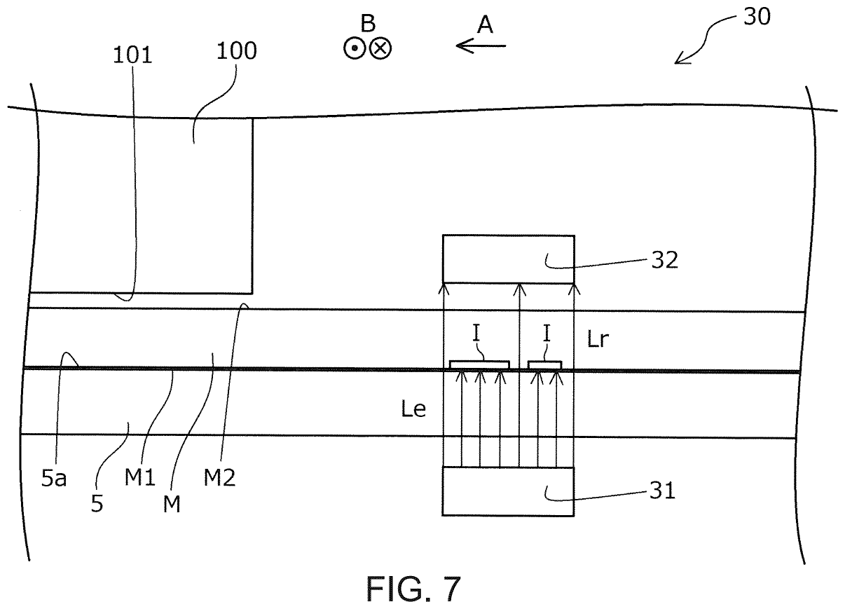

Next, a printing device 1C according to a third embodiment will be described with reference to FIGS. 6 and 7. FIG. 6 is a view corresponding to FIG. 1 of the printing device 1A of the first embodiment, and FIG. 7 is a view corresponding to FIG. 2 of the printing device 1A of the first embodiment. In FIGS. 6 and 7, components that are common to those in the above first and second embodiments are indicated by the same symbols, and detailed explanations are omitted. Here, the printing device 1C of the present embodiment has the same configuration as printing device 1 of the first embodiment and second embodiment except for the configuration of the infrared imaging section 30. For this reason, the printing device 1C of the present embodiment has the same features as those of the printing device 1 of the first embodiment and the second embodiment, except for the parts described below.

As described above, in printing device 1 of the first embodiment and second embodiment, the infrared imaging section 30 includes the light emitting section 31 and the light receiving section 32 provided on the same side with respect to the first surface M1 and the second surface M2 of the medium M. On the other hand, as illustrated in FIGS. 6 and 7, in the printing device 1C of the present embodiment, the infrared imaging section 30 includes the light emitting section 31 on the side facing the first surface M1 and the light receiving section 32 on the side facing the second surface M2. In printing device 1C of the present embodiment, transport belt 5 is formed of a material through which infrared rays pass, as in printing device 1B of the second embodiment. Since printing device 1C of the present embodiment has such a configuration, light emitting section 31 and light receiving section 32 can be disposed on different sides with respect to transport belt 5, thereby effectively utilizing the space in the device.

### FOURTH EMBODIMENT

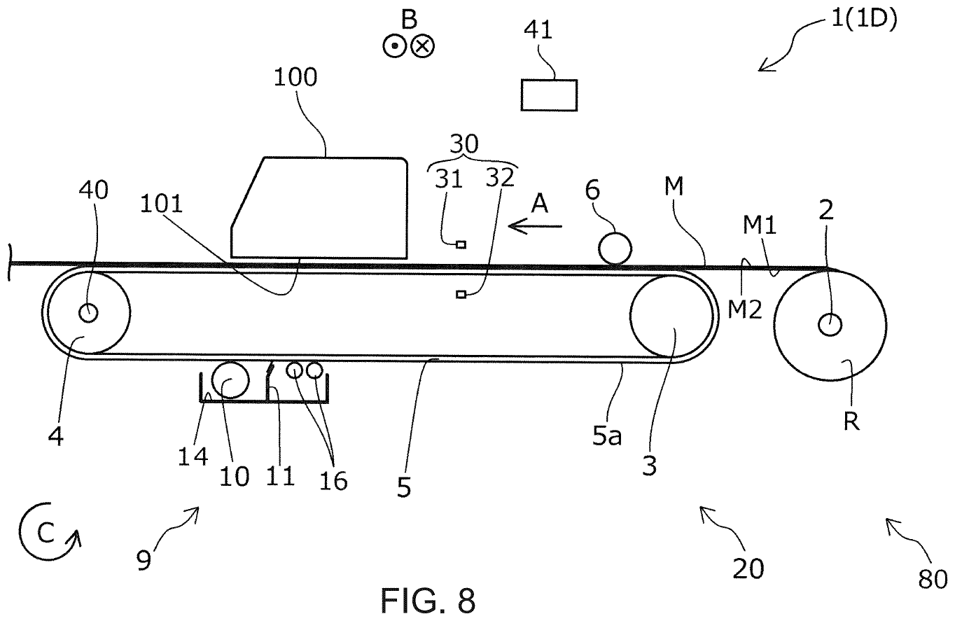

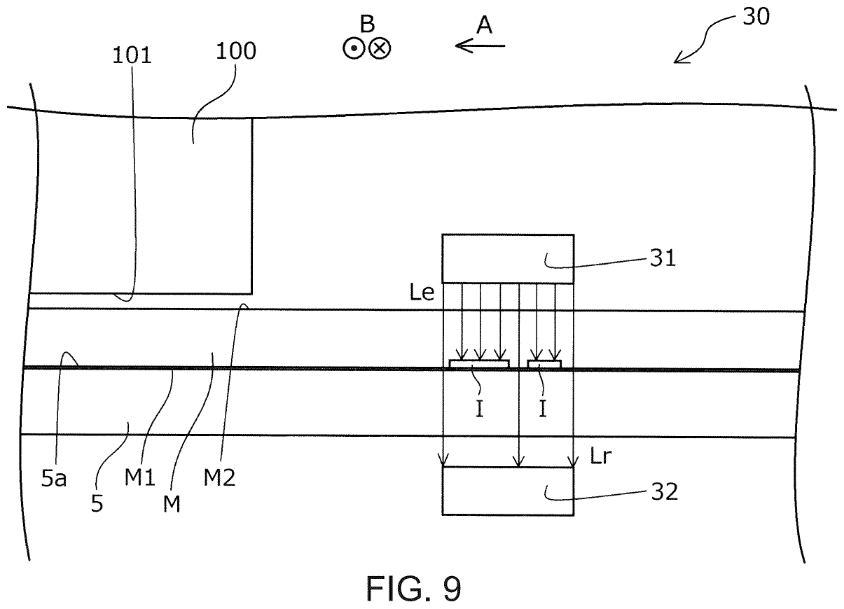

Next, a printing device 1D according to a fourth embodiment will be described with reference to FIGS. 8 and 9. FIG. 8 is a view corresponding to FIG. 1 of the printing device 1A of the first embodiment, and FIG. 9 is a view corresponding to FIG. 2 of the printing device 1A of the first embodiment. In FIGS. 8 and 9, components that are common to those in the above first to third embodiments are indicated by the same symbols, and detailed explanations are omitted. Here, the printing device 1D of the present embodiment has the same configuration as that of the printing device 1 of the first to third embodiments except for the configuration of the infrared imaging section 30. For this reason, the printing device 1D of the present embodiment has the same features as those of the printing device 1 of first to third embodiment, except for the parts described below.

As described above, in the printing device 1C of the third embodiment, the infrared imaging section 30 includes the light emitting section 31 on the side facing the first surface M1 and the light receiving section 32 on the side facing the second surface M2. On the other hand, as illustrated in FIGS. 8 and 9, in the printing device 1D of the present embodiment, the infrared imaging section 30 includes the light emitting section 31 on the side facing the second surface M2 and the light receiving section 32 on the side facing the first surface M1. In printing device 1D of the present embodiment, as in printing device 1C of the third embodiment, transport belt 5 is formed of a material through which infrared rays pass. Since printing device 1D of the present embodiment has such a configuration, similarly to printing device 1C of the third embodiment, the light emitting section 31 and the light receiving section 32 can be disposed on different sides with respect to transport belt 5, and the space in the device is effectively utilized.

It should be noted that the present disclosure is not limited to the above embodiments, and various modifications can be made within the scope of the disclosure described in the claims, and it goes without saying that these are also included within the scope of the present disclosure.

What is claimed is:

1. A printing device comprising:
a transport belt that includes an adhesive layer for supporting a fabric as a medium and that transports the fabric in a transport direction in a state where a first surface of the fabric faces the adhesive layer;
a printing section that prints an image on a second surface of the fabric transported by the transport belt, the second surface being on an opposite side than the first surface; and
an infrared imaging section that captures an image of an imaging target provided on the first surface by using infrared rays with respect to the fabric transported by the transport belt.

2. The printing device according to claim 1, further comprising:
a correction section that corrects at least one of the image and
the printing position of the image based on imaging data captured by the infrared imaging section.

3. The printing device according to claim 1, further comprising:
a pressing section that presses the fabric to the adhesive layer.

4. The printing device according to claim 1, wherein
the transport belt is formed of a material that reflects infrared rays and
the infrared imaging section includes a light emitting section that emits infrared light and a light receiving section that receives infrared light on a side facing the second surface.

5. The printing device according to claim 1, wherein
the transport belt is formed of a material through which infrared rays pass and
the infrared imaging section includes a light emitting section that emits infrared light and a light receiving section that receives infrared light both on a side facing the first surface.

6. The printing device according to claim 1, wherein
the transport belt is formed of a material through which infrared rays pass and
the infrared imaging section includes a light emitting section that emits infrared light on a side facing the first surface and a light receiving section that receives infrared light on a side facing the second surface.

7. The printing device according to claim 1, wherein
the transport belt is formed of a material through which infrared rays pass and
the infrared imaging section includes a light emitting section that emits infrared light on a side facing the second surface and a light receiving section that receives infrared light on a side facing the first surface.

8. The printing device according to claim 1, wherein
the infrared imaging section is detachable and attachable.

9. The printing device according to claim 1, wherein
the image target is a print image printed in advance by the printing section.

10. A printing method of a printing device, the printing device including
a transport belt that includes an adhesive layer for supporting a fabric as a medium and that transports the fabric in a transport direction in a state where a first surface of the fabric faces the adhesive layer and
a printing section that prints an image on a second surface of the fabric transported by the transport belt, the second surface being on an opposite side than the first surface, the method comprising:
an infrared imaging step of capturing an image of an imaging target provided on the first surface by using infrared rays with respect to the fabric transported by the transport belt,
a correction step of correcting at least one of the image and a printing position of the image based on the imaging data captured in the infrared imaging step, and
a printing step of printing the image on the fabric transported by the transport belt by the printing section based on a correction result of the correction step.

11. The printing method according to claim 10, wherein
prior to the infrared imaging step, an imaging target printing step of printing the imaging target is executed by the printing section.
